(19) United States
(12) Patent Application Publication
(10) Pub. No.: US 2026/0118993 A1
(43) Pub. Date: Apr. 30, 2026

(54) DETECTION LINE BROADENING

(71) Applicant: FlatFrog Laboratories AB, Lund (SE)

(72) Inventors: Håkan Bergström, Torna-Hällestad (SE); Thomas Craven-Bartle, Sodra Sandby (SE); Tomas Svensson, Limhamn (SE)

(21) Appl. No.: 19/423,492

(22) Filed: Dec. 17, 2025

Related U.S. Application Data
(63) Continuation of application No. 18/155,669, filed on Jan. 17, 2023, now Pat. No. 12,524,116.
Application No. 18/155,669 is a continuation of application No. 16/977,665, now Pat. No. 11,567,610.

(30) Foreign Application Priority Data
Mar. 5, 2018 (SE) 1830076-4

(51) Int. Cl. G06F 3/042; G02B 5/02; G02B 6/42

(52) U.S. Cl. CPC G06F 3/0421; G02B 5/021; G02B 5/0236; G02B 5/0278; G02B 5/0284; G02B 6/4206

(57) ABSTRACT

A touch sensing apparatus is disclosed comprising a panel that defines a touch surface, a plurality of emitters and detectors arranged along a perimeter of the light transmissive panel, and a light directing arrangement arranged adjacent the perimeter. The emitters are arranged to emit a respective beam of emitted light and the light directing arrangement is arranged to direct the light along a light path from the emitters to the touch surface. A diffusive light scattering element is arranged in the light path.

### TECHNICAL FIELD

The present disclosure pertains to touch-sensing apparatus that operate by propagating light above a panel. More specifically, it pertains to optical and mechanical solutions for controlling and tailoring the light paths above the panel via fully or partially randomized refraction, reflection or scattering.

### BACKGROUND ART

In one category of touch-sensitive panels known as ‘above surface optical touch systems’, a set of optical emitters are arranged around the periphery of a touch surface to emit light that is reflected to travel and propagate above the touch surface. A set of light detectors are also arranged around the periphery of the touch surface to receive light from the set of emitters from above the touch surface. I.e. a grid of intersecting light paths are created above the touch surface, also referred to as scanlines. An object that touches the touch surface will attenuate the light on one or more scanlines of the light and cause a change in the light received by one or more of the detectors. The location (coordinates), shape or area of the object may be determined by analyzing the received light at the detectors.

Previous above surface touch technology has problems with detectability, accuracy, jitter and object size classification, related to suboptimal scanline width, component count and touch decoding. The width of the scanlines affects touch performance factors such as detectability, accuracy, resolution, the presence of reconstruction artefacts. Problems with previous prior art touch detection systems relate to sub-optimal performance with respect to the aforementioned factors. Some prior art systems aim to improve the accuracy in detecting small objects. This in turn may require incorporating more complex and expensive opto-mechanical modifications to the touch system, such as increasing the number of emitters and detectors, to try to compensate for such losses. This results in a more expensive and less compact system. Furthermore, to reduce system cost, it may be desirable to minimize the number of electro-optical components.

### SUMMARY

According to a first aspect, a touch sensing apparatus is provided comprising: a panel that defines a touch surface, a plurality of emitters and detectors arranged along a perimeter of the panel, a light directing arrangement arranged adjacent the perimeter, wherein the emitters are arranged to emit a respective beam of emitted light and the light directing arrangement is arranged to direct the light along a light path from the emitters to the touch surface, wherein the light directing arrangement comprises a diffusive light scattering element arranged in the light path.

Some examples of the disclosure provide for a touch sensing apparatus wherein the light directing arrangement comprises a light guide component and wherein the emitted light enters the light guide component at a first surface and exits the light guide component at a second surface.

Some examples of the disclosure provide for a touch sensing apparatus wherein the diffusive light scattering element is a reflective diffusor and is arranged at a surface of the light guide component to diffuse light travelling in the light guide component

Some examples of the disclosure provide for a touch sensing apparatus wherein the diffusive light scattering element is a transmissive diffusor and is arranged at the first surface so that the light is diffused when entering the light guide component.

Some examples of the disclosure provide for a touch sensing apparatus wherein the diffusive light scattering element is a transmissive diffusor and is arranged at the second surface so that the light is diffused when exiting the light guide component.

Some examples of the disclosure provide for a touch sensing apparatus wherein the diffusive light scattering element comprises at least one of an engineer diffusor, a substantially Lambertian diffusor, or a coating.

Some examples of the disclosure provide for a touch sensing apparatus wherein the diffusive light scattering element is bulk scattering particles in the material of the light guide component

Some examples of the disclosure provide for a touch sensing apparatus wherein the diffusive light scattering element is a reflector surface.

Some examples of the disclosure provide for a touch sensing apparatus wherein the diffusive light scattering element comprises at least one of a structured reflector surface, a substantially Lambertian diffusor, or a film or coating, and a surface of a component.

Some examples of the disclosure provide for a touch sensing apparatus wherein the light directing arrangement further comprises an angular filter structure arranged in the light path and configured to restrict the emitted light being scattered by the diffusive light scattering element in said light path to a determined angular range in relation to the touch surface.

Some examples of the disclosure provide for a touch sensing apparatus wherein the angular filter structure comprises a longitudinal portion extending in a direction parallel with the touch surface.

Some examples of the disclosure provide for a touch sensing apparatus wherein the longitudinal portion is arranged between the touch surface and a frame element extending above the touch surface to form a transparent sealing portion therebetween.

Some examples of the disclosure provide for a touch sensing apparatus wherein the diffusive light scattering element is arranged in the light path between the emitters and the angular filter structure.

Some examples of the disclosure provide for a touch sensing apparatus wherein the diffusive light scattering element is arranged below the touch surface.

Some examples of the disclosure provide for a touch sensing apparatus wherein the plurality of emitters and/or detectors are arranged above the touch surface.

Some examples of the disclosure provide for a touch sensing apparatus wherein the reflector surface comprises a grooved surface and wherein the grooves are orientated in the plane of the light path.

Some examples of the disclosure provide for a touch sensing apparatus wherein the grooves are formed from scratching or brushing.

Some examples of the disclosure provide for a touch sensing apparatus wherein the reflector surface is a anodized metal.

Still other objectives, features, aspects and advantages of the present disclosure will appear from the following detailed description, from the attached claims as well as from the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

These and other aspects, features and advantages of which examples of the disclosure are capable of will be apparent and elucidated from the following description of examples of the present disclosure, reference being made to the accompanying drawings, in which;

FIGS. 1a-b are schematic illustrations, in cross-sectional side views, of a touch-sensing apparatus, according to one example;

FIGS. 2a-b are schematic illustrations of a light directing arrangement and a diffusive light scattering element according to examples of the disclosure;

FIGS. 3a-b are schematic illustrations of an angular filter structure according to examples of the disclosure, in a perspective view and in a side view, respectively;

FIG. 4 is a schematic illustration, in a cross-sectional side view, of a touch-sensing apparatus, according to one example;

FIG. 5 is a schematic illustration, in a cross-sectional side view, of a touch-sensing apparatus, according to one example;

FIG. 6a is a schematic illustration, in a cross-sectional side view, of a touch-sensing apparatus, according to one example;

FIG. 6b is a schematic illustration, in a top-down view, of the touch-sensing apparatus in FIG. 6a, according to one example;

FIG. 6c is a schematic illustration, in a cross-sectional side view, of an emitter and a diffusive light scattering element according an example of the disclosure;

FIG. 6d is a schematic illustration, in a top-down view, of the emitter and the diffusive light scattering element in FIG. 6c, according to one example;

FIG. 7a is a schematic illustration, in a cross-sectional side view, of an emitter, an angular filter structure, and a diffusive light scattering element, or engineered diffuser, according an example of the disclosure;

FIG. 7b is a schematic illustration, in a top-down view, of the emitter, angular filter structure, and diffusive light scattering element, or engineered diffuser, in FIG. 7a, according to one example;

FIG. 8 is a schematic illustration, in a cross-sectional side view, of a touch-sensing apparatus, according to one example;

FIGS. 9a-b are schematic illustrations, in cross-sectional side views, of an angular filter structure and a diffusive light scattering element according to examples of the disclosure; and

FIG. 10a is a schematic illustration, in a cross-sectional side view, of a touch-sensing apparatus, according to one example;

FIG. 10b is a schematic illustration, in a top-down view, of the touch-sensing apparatus in FIG. 10a, according to one example;

FIGS. 11a-b are schematic illustrations, in cross-sectional side views, of a touch-sensing apparatus, according to examples of the disclosure;

FIG. 12 is a schematic illustration, in a cross-sectional side view, of a touch-sensing apparatus, according to one example;

FIG. 13 is a schematic illustration, in a cross-sectional side view, of a touch-sensing apparatus, according to one example;

FIG. 14 is a schematic illustration, in a cross-sectional side view, of a touch-sensing apparatus, according to one example;

FIG. 15 is a schematic illustration, in a cross-sectional side view, of a touch-sensing apparatus, according to one example;

FIG. 16 is a diagram showing the total reflectance (%) for black anodized aluminium as function of the wavelength (nm); and

FIG. 17 is a schematic illustration, in a cross-sectional side view, of a touch-sensing apparatus, according to one example.

### DETAILED DESCRIPTION OF EXAMPLE EMBODIMENTS

In the following, embodiments of the present disclosure will be presented for a specific example of a touch-sensitive apparatus. Throughout the description, the same reference numerals are used to identify corresponding elements.

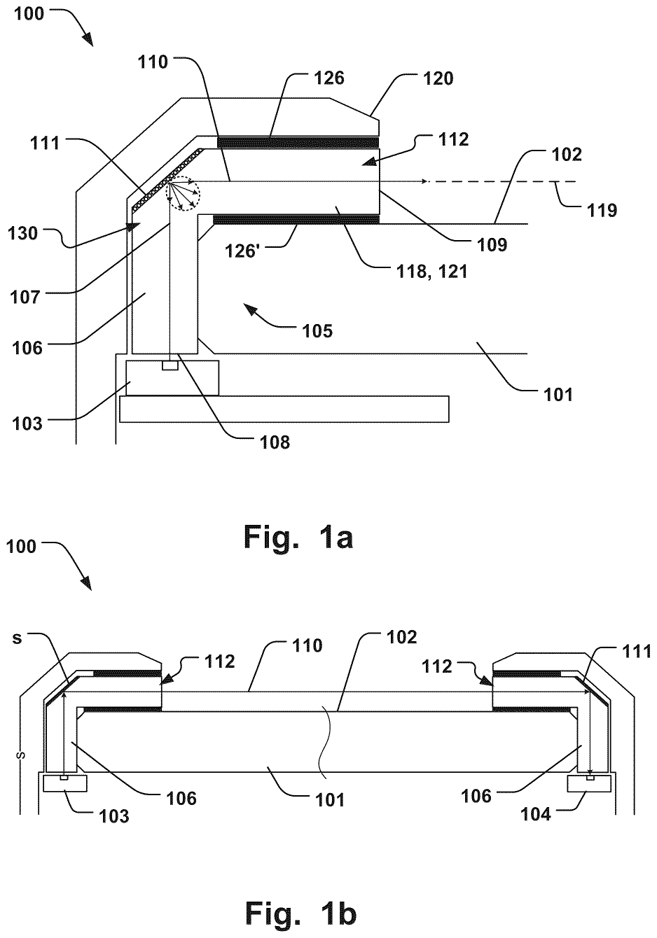

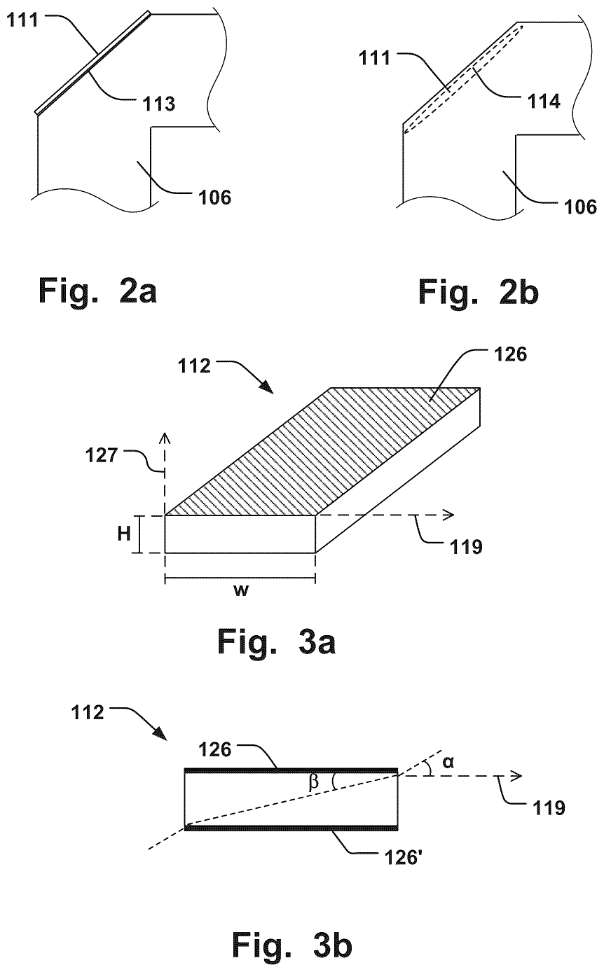

FIGS. 1a and 1b are schematic illustrations of a touch-sensing apparatus 100 comprising a light transmissive panel 101 that defines a touch surface 102, and a plurality of emitters 103 and detectors 104 arranged along a perimeter 105 of the light transmissive panel 101. FIG. 1a shows only an emitter 103 for clarity of presentation, while FIG. 1b illustrates how light is transmitted from an emitter 103 to a detector 104 across the touch surface 102. The touch-sensing apparatus 100 comprises a light directing arrangement 130 comprising a light coupling element 106, also referred to as a light guide component 106 in this disclosure, arranged adjacent and along the perimeter 105. The emitters 103 are arranged to emit a respective beam of emitted light 107 and the light coupling element 106 is arranged to receive the emitted light 107 through a first surface 108 and couple out light travelling in the light coupling element 106 through a second surface 109 thereof to direct the emitted light 107 in a light path 110 from the emitters 103 and across touch surface 102 of the panel 101. The touch-sensing apparatus 100 comprises a diffusive light scattering element 111 arranged in the light path 110. I.e. the light emitted from emitters 103 is scattered by the diffusive light scattering element 111 in the path 110 between the emitters 103 and the touch surface 102. A corresponding concept is schematically illustrated in the examples of FIGS. 1b, 2a-b, 4, 5, 6a-d, 7a-b, 8, 9a-b, 10a-b, 11a-b, 12, 13, 14, 15 and 17.

The diffusive light scattering element 111 may be arranged on an external surface 113 of the light coupling element 106, as schematically illustrated in FIG. 2a. Hence, the diffusive light scattering element 111 may be attached to or otherwise incorporated onto the light coupling element 106, as well as an optional angular filter structure 112 (effectively being part of the light coupling element 106 in the various examples of the disclosure). This may provide for achieving an efficient transmission of light along a desired light path 110, as well as a facilitated alignment of the optical elements along the path 110. Relaxed alignment requirements is beneficial for mass production.

The diffusive light scattering element 111 may be incorporated into an internal surface 114 of the light coupling element 106, as schematically illustrated in FIG. 2b. The diffusive light scattering element 111 may also be arranged at the first surface 108 or second surface 109. The diffusive light scattering element 111 may also be distributed in the light coupling element 106, e.g. by introducing bulk scattering, e.g. by adding TiO₂, or any other suitable material for scattering the light. Examples of different diffusive light scattering elements 111 are described later in the description.

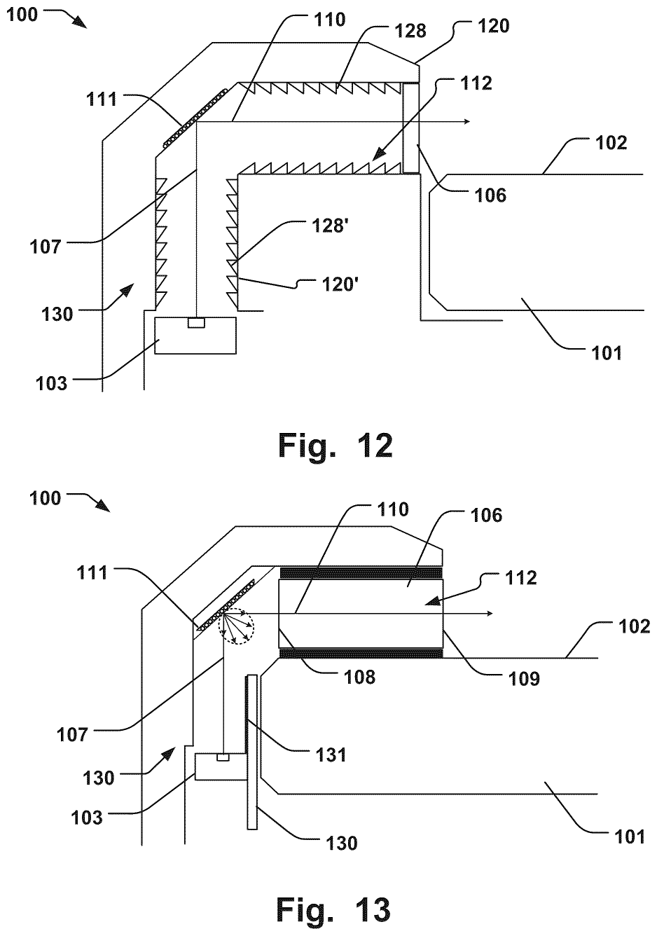

In some embodiments, the touch-sensing apparatus 100 may comprise an angular filter structure 112 arranged in the light path 110. The angular filter structure 112 is configured to confine the emitted light 107, which is scattered by the light scattering element 111 in the light path 110, to a determined angular range in relation to the touch surface 102. Thus, the spreading of the light emitted from emitters 103 is reduced and limited to a defined angle by the angular filter structure 112 in the path 110 between the emitters 103 and the touch surface 102, as schematically illustrated in the examples of FIGS. 1a-b, 4, 5, 6a-d, 7a-b, 8, 10a-b, 11a-b, 12, 13, and 14. Angular filtering may be provided by having light absorbing surfaces 126, 126′, arranged at the angular filtering structure 112, that prevents light from being reflected through light absorbing surfaces 126, 126′. FIGS. 3a-b show an example of at least a part of such angular filtering structure 112, with light absorbing surfaces 126, 126′, arranged at opposite sides thereof in a direction 127 being a normal direction to a plane in which the touch surface 102 extends. The light absorbing surfaces 126, 126′, are separated by the height (H), and extend with a width (w) in a direction 119 parallel with the plane in which the touch surface 102 extends. Referring to FIG. 3b, the relationship between a maximum angle α (αₘₐₓ) and the maximum angle β (βₘₐₓ) is given by; sin αₘₐₓ=n*sin βₘₐₓ, where n is the refractive index of the material between the light absorbing surfaces 126, 126′, in which the reflection occurs. βₘₐₓ can be determined in relation to the dimensions H and w as; βₘₐₓ=arctan(H/w). Thus, the dimensions H and w, and the refractive index n can be chosen to so that αₘₐₓ is limited and the emitted light can be confined to a desired angle relative to the direction 119. For example, H/w=0.2, and n=1.5 gives αₘₐₓ=17.1°. The angular filtering structure 112 will also provide for blocking ambient light entering detectors 104 at the defined angular range. The angular filtering structure 112 may comprise other structures that prevent light scattering, such as absorbing surfaces 128, 128′, discussed further in relation to FIG. 12. It is also conceivable that the angular filtering structure 112 comprises light collimating surfaces.

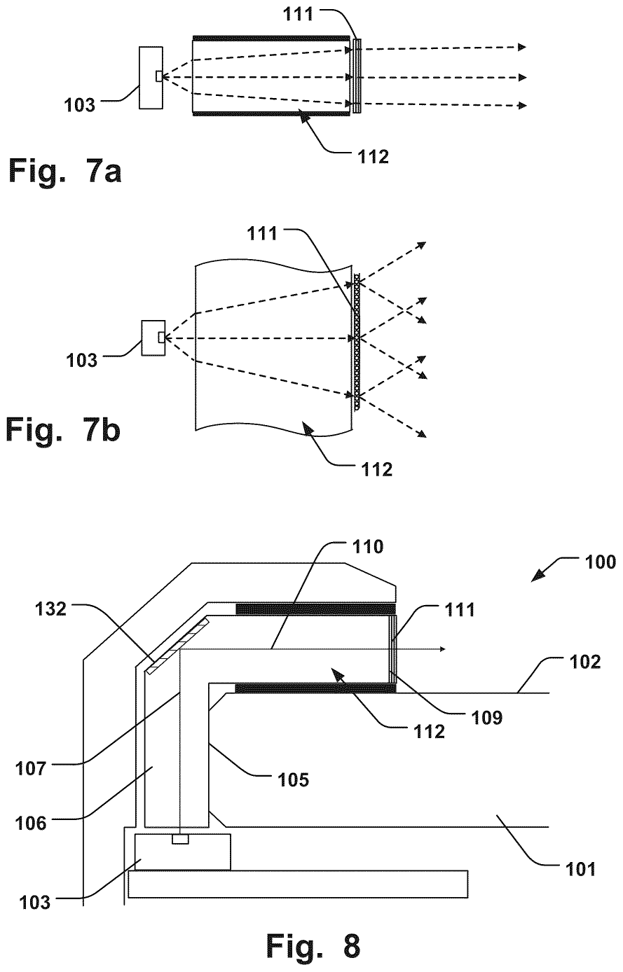

While some examples, such as those schematically illustrated in e.g. FIGS. 1a-b, 4, 5, 6a-d, 10a-b, 11a-b, 12, 13, and 14, show the angular filter structure 112 being arranged to limit the spread of emitted light 107 that has been scattered by the diffusive light scattering element 111, it is conceivable that the emitted light 107 is first confined by the angular filter structure 112 to a desired angle and then scattered by the diffusive light scattering element 111, as schematically illustrated in FIGS. 7a-b, and 8.

One embodiment provides an arrangement comprising both a diffusive light scattering element 111 to diffusively scatter the emitted light 107, as well as an angular filter structure 112 in the light path 110. This embodiment provides for broadening the emitted light 107 in a first direction and restricting the spread of the emitted light 107 in a second direction, such as in opposite directions, e.g. with the first direction being perpendicular to the second direction. Limiting the angle by which the light is spread in the second direction provides for reducing the risk of stray light effects, i.e. light is not sent in directions where it is not wanted. Further, as mentioned above, this also provides for blocking of ambient light since only light incident at the defined angular range will reach the detectors 104. Interference with the light detection may thus be reduced. Turning to the example in FIG. 1a, the diffusive light scattering element 111 may thus diffusively scatter the emitted light 107, while the angular filter structure 112 restricts the spread of the scattered light outside the plane of the touch surface 102. The diffusive light scattering element 111 may be arranged and configured to predominantly scatter the light in the plane of the touch surface 102, and the angular filter structure 112 allows to further restrict the angle by which the light spreads from the plane of the touch surface 102.

The angular filter structure 112 may comprise a longitudinal portion 118 of the light coupling element 106 extending in a direction 119 parallel with the touch surface 102, as well as along the perimeter 105, as schematically illustrated in e.g. FIGS. 1a-b, 3a-b, 4, 5, 6a, 8, 10a, 11a-b, 13, and 14. Having a longitudinal portion 118 extending in the direction 119 of the plane of the touch surface 102 provides for efficiently confining the spread of the light in the aforementioned plane. It is conceivable that the angular filter structure 112 comprises other elements such as lenses to optimize the confinement of the light in various applications.

The longitudinal portion 118 may be arranged between the touch surface 102 and a frame element 120 extending above the touch surface 102 to form a transparent sealing portion 121 therebetween, as schematically illustrated in e.g. FIG. 1a. Thus, the angular filter structure 112 and the longitudinal portion 118 thereof may simultaneously provide for sealing between the panel 101 and the frame element 120. This provides for a compact profile of the touch-sensing apparatus along the periphery 105 thereof.

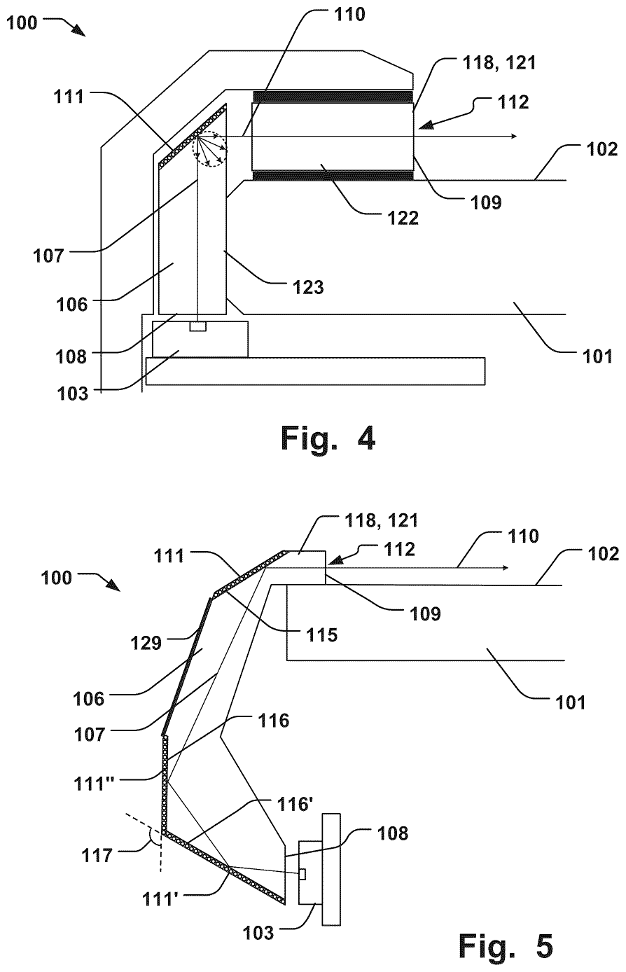

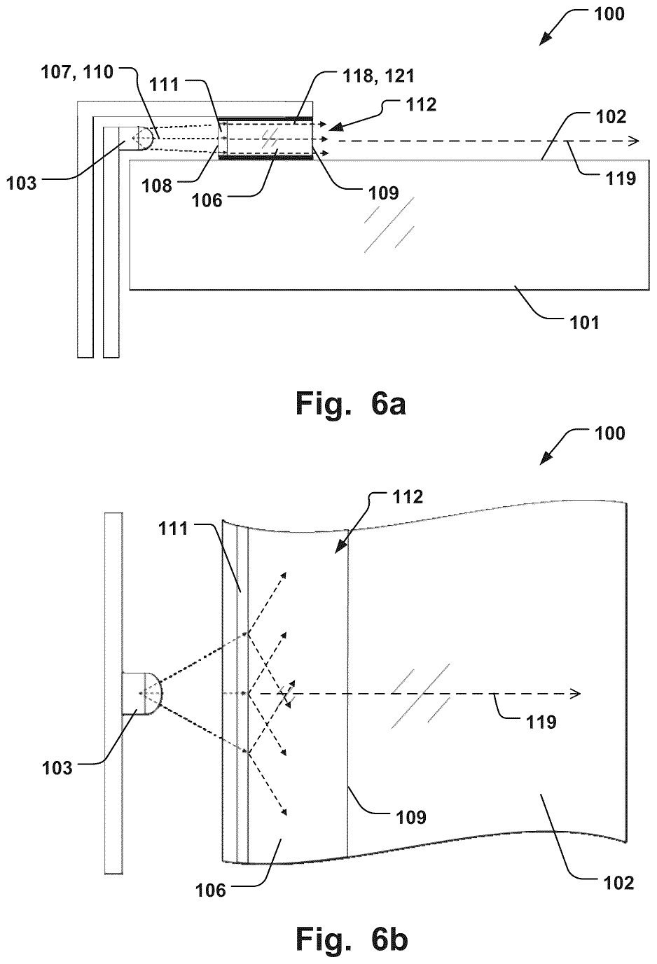

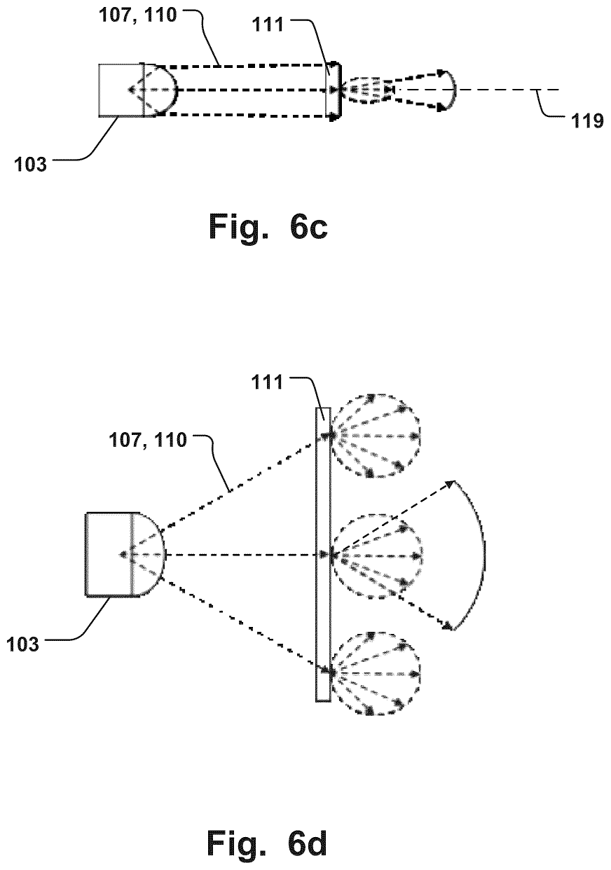

As seen in the example of FIG. 4, a longitudinal portion 118 may form a second portion 122 of the light coupling element 106 being separated from a first portion 123 thereof. The first portion 123 may comprise the aforementioned first surface 108. The first portion 123 may further be arranged at least partly outside the perimeter 105. Thus, FIG. 4 show one example where the longitudinal portion 118 is separated from a first portion 123 of the light coupling element 106. Emitted light is scattered at diffusive light scattering element 111 towards the angular filter structure 112 and the longitudinal portion 118 thereof. In this example the diffusive light scattering element 111 is arranged at the first portion 123. The diffusive light scattering element 111 may also be arranged on the second portion 118. In the example of FIG. 6a, the light coupling element 106 and angular filter structure 112 is formed as an integral piece, extending in a longitudinal direction along the plane of the touch surface 102. In the latter example, the first portion 123 of the light coupling element has been omitted since the emitter 103 is arranged above the touch surface 102.

The light coupling element 106 may comprises at least two internal reflection surfaces 115, 116, 116′, arranged for reflecting and coupling the emitted light between the aforementioned first and second surfaces 108, 109, as schematically illustrated in FIG. 5. The diffusive light scattering element 111 may be arranged along the at least two internal reflection surfaces 115, 116, 116′, as indicated by diffusive light scattering elements 111, 111′, 111″. Extending the length of the light path 110 by introducing more reflections, and having a plurality of reflections at diffusive light scattering elements 111, 111′, 111″, in the light coupling element 106 provides for utilizing a larger portion of the emitted light 107. This is also provided for by having reflection surfaces 116, 116′, configured for specular reflection. The signal to noise ratio may thus be improved. FIG. 5 is one example of having a plurality of diffusive light scattering elements 111, 111′, 111″, and it is conceivable that any plurality of such elements may be provided in the light path 110. The angular filter structure 112 is arranged at the touch surface 102 to suppress reflections in directions out of the plane of the touch surface 102. Reflection surface denoted with numeral 129 may be provided with a black film to restrict ambient or stray light. The at least two internal reflection surfaces 116, 116′, may intersect each other at an angle 117, e.g. as illustrated in FIG. 5. The angle 117 may be varied to achieve the desired propagation of light along the light coupling element 106.

The plurality of emitters 103 and/or detectors 104 may be arranged above the touch surface 102, as illustrated in the examples of FIGS. 6a-b, 10a-b, 11b. This may be desirable in some applications, and can provide for facilitated alignment of the emitters 103/detectors 104, and/or a facilitated manufacturing process.

The diffusive light scattering element 111 may be arranged in the light path 110 between the emitters 103 and the angular filter structure 112, as shown in the examples of FIGS. 1a-b, 4, 5, 6a-d, 10a-b, 11a-b, 12, 13, and 14. The angular filter structure 112 may thus effectively block light that is not in the plane of the touch surface 102, thus improving ambient and stray light rejection. The arrangement schematically illustrated in FIG. 1a may at the same time provide for a particular compact and robust assembly of the touch-sensing apparatus 100 with a minimal number of individual parts. The example of FIG. 1a show the angular filter structure 112 integrated as a part of the light coupling element 106 receiving the emitted light through the first surface 108. The light coupling element 106 also incorporates the diffusive light scattering element 111 at an angled surface arranged above the touch surface 102. Although, as explained further below, the diffusive light scattering element 111 may be arranged in the light path 110 between the emitters 103 and the angular filter structure 112 in various other configurations.

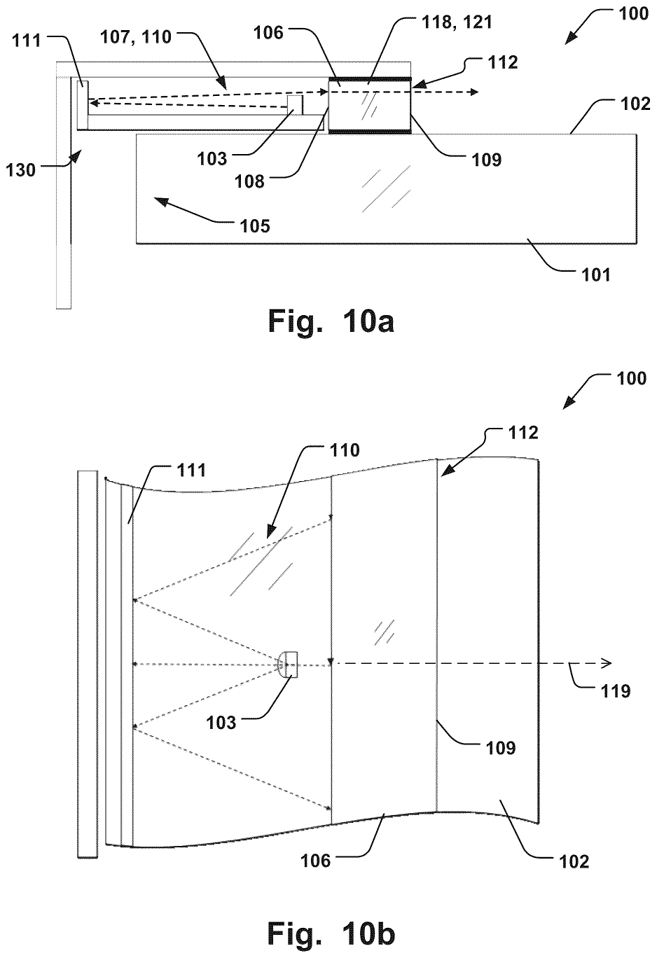

The diffusive light scattering element 111 may extend at least partly above the touch surface 102, as schematically illustrated in e.g. FIGS. 1a-b, 4, 5, 10a-b, 11a-b, 13, and 14. The diffusive light scattering element 111 is positioned in relation to the emitters 103 to scatter the emitted light 110. In the examples of e.g. FIGS. 1a-b, 4, 5, 6a-d, 10a-b, 11a-b, 13, and 14, the angular filter structure 112 receives the scattered light. Having a separation between the emitters 103 and the diffusive light scattering element 111, as allowed by e.g. positioning the latter above the touch surface 102, and arranging the emitters 103 below the touch surface 102 may provide for increasing the effective size of the emitters 103 and detectors 104, i.e. broadening of the scanlines, and also a compact profile of the touch-sensing apparatus around the periphery 105. A more effective scattering may also be provided by folding and extending the light path 110 as further described in relation to FIGS. 10a-b, 11a, and 5.

The diffusive light scattering element 111 may be arranged at least partly outside the perimeter 105, as schematically illustrated in e.g. FIGS. 1a, 4, 12, 13, 5, 14. This allows for directing the light path 110 around the sides of the panel 101, thus avoiding any loss of light through the panel 101 itself, while having a compact arrangement with emitters and detectors 103, 104, below the touch surface 102.

FIGS. 6a-b show another example of how the emitter 103 may be arranged in relation to the diffusive light scattering element 111 and the angular filter structure 112, which will be discussed further below. FIGS. 6a-b show an embodiment using an LED with an asymmetric lens, thus emitting light having an angular distribution wider in one direction than another. FIG. 6c shows a light path of the emitted light in FIG. 6a, i.e. in a cross-sectional view. Thus, as illustrated, the spread of the emitted light 107 from a direction 119 parallel to the touch surface 102 may be minimal, e.g. ±5° or less, while a significant broadening, e.g. ±45° or more, such as ±75°, is provided in the plane of the touch surface 102, as illustrated in the top-down view of the light path 110 in FIG. 6d corresponding to top down view of the touch-sensing apparatus 100 in FIG. 6b. This enables for more scan lines to cross the touch surface 102, and provides for reducing the risk of missing small objects with the grid of scanlines across the touch surface 102. At the same time the number of emitters 103 and detector 104 can be kept at a minimum. The scanlines are effectively broadened in the plane of the touch surface 102, and any “gaps” between scanlines can be reduced or avoided. A scanline is defined as having a width. The scanline width is the width of the portion of light travelling from the emitter to the detector that can be used to detect an interrupting object between the emitter and detector, wherein the width is measured perpendicular to the scanline direction. In the present disclosure, the broadening of a scanline is defined to mean the increase in scanline width. Therefore, through broader scanlines, the resolution and accuracy of the touch-sensing apparatus 100 may thus be improved and the touch performance is increased. There will also be less variation in the attenuation of the detection signal for all types of objects as the objects move, which thus improves the classification abilities of various objects used on the touch surface 102. At the same time, the need to introduce a more complex arrangement of optical, mechanical or electrical components, such as increasing the number of emitters 103 and detectors 104 is alleviated, while still achieving a better scanline coverage across the touch panel 102. Having an angular filter structure 112 and a diffusive light scattering element 111 arranged in the light path 110 as described thus provides for effectively shaping the light beams for an optimized coverage in the plane of the touch surface 102, while scattering out from said plane is minimized. The interplay between the emitters 103 and the detectors 104 and their relative arrangement can be optimized to effectively provide for broadening of the scanlines, since several emitters 103 and detectors 104 may interact for each scanline. The position of the diffusive light scattering element 111 in relation to the emitters 103, angular filter structure 112, and the panel 102 may be varied as described further below for optimization of the performance of the touch-sensing apparatus 100 to various applications. Further variations are also conceivable within the scope of the present disclosure while providing for the advantageous benefits as generally described herein. The described examples refer primarily to aforementioned elements in relation to the emitters 103, to make the presentation clear, although it should be understood that the corresponding arrangements also apply to the detectors 104.

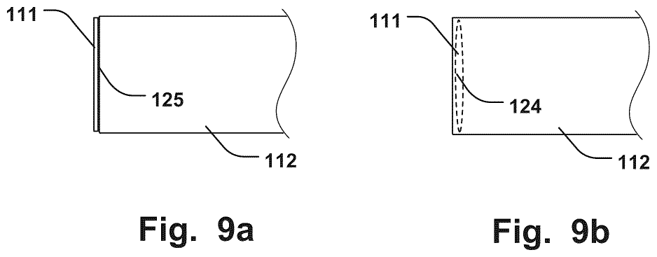

The diffusive light scattering element 111 may be arranged at an internal 124 and/or external 125 surface of the angular filter structure 112, as schematically illustrated in FIGS. 9a-b. It can also be implemented by distributing scattering particles (e.g. TiO2) throughout the bulk of the angular filter structure 112.

The illustrated section of the angular filter structure 112 in FIGS. 9a-b may correspond to the longitudinal portion 118 referred to above. I.e. FIGS. 9a-b may be construed as magnified views of a section of the longitudinal portion 118.

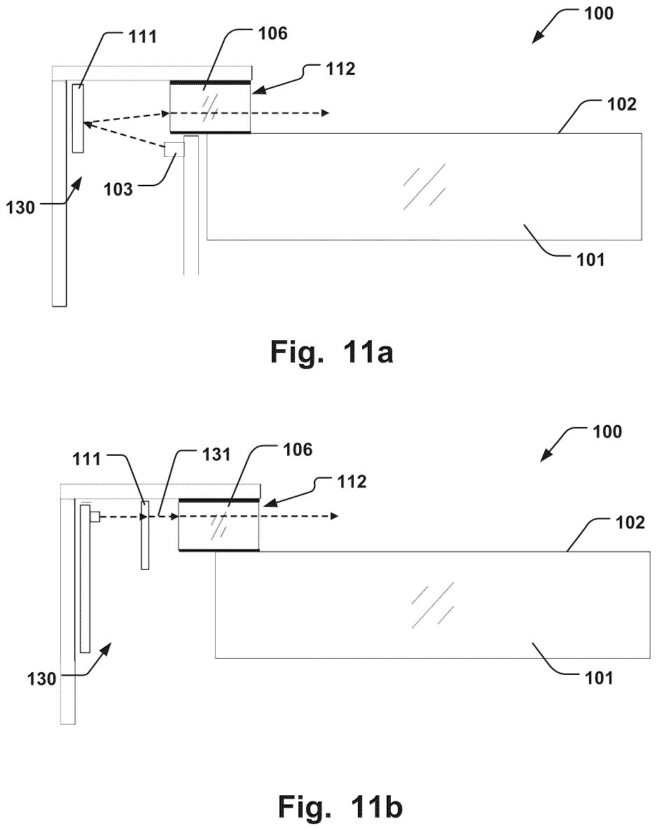

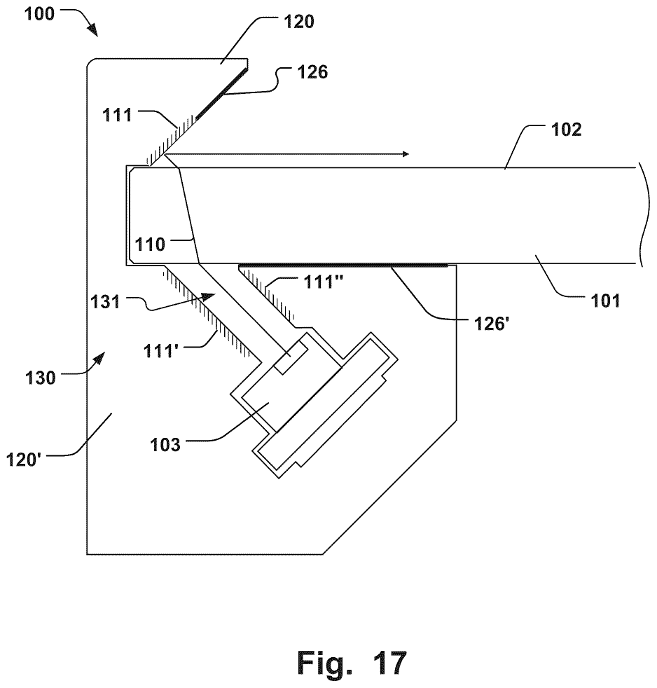

In some embodiments, a light directing arrangement 130 comprises a diffusive light scattering element 111 independent from any light coupling element 106 and/or the angular filter structure 112, as schematically illustrated in FIGS. 10a-b, 11a-b, 12, 13, 14, 15, and FIG. 17. For example, turning to FIG. 11b, the diffusive light scattering element 111 is placed between the emitter 103 and the light coupling element 106/angular filter structure 112, with a spacing 131 from the latter, compared to the example shown in FIG. 6a where the diffusive light scattering element 111 is attached to or incorporated into the light coupling element 106/angular filter structure 112. FIG. 11a illustrates a further example of having a separated diffusive light scattering element 111, and folding of the light path 110, as will be described in more detail below.

The diffusive light scattering element 111 may be arranged at, or in, the surface 108 receiving the emitted light 107 from the emitters 103, as schematically illustrated in FIG. 6a. The diffusive light scattering element 111 is still arranged at a distance from the emitter 103 so that the scanline is broadened. A larger the separation between the emitter 103 and the diffusive light scattering element 111 provides for a broader scan line.

The plurality of emitters 103 may be arranged above the touch surface 102 and between the diffusive light scattering element 111 and the angular filter structure 112. Further, the emitters 103 may be arranged to emit light outwards from the touch surface 102 towards the perimeter 105 thereof for diffusive reflection at the diffusive light scattering element 111, as schematically illustrated in FIGS. 10a-b. I.e. the emitted light is scattered back towards the emitter 103 and the light coupling element 106/angular filter structure 112. Such arrangement may be advantageous in some applications for providing a further broadening of the scanlines across the touch surface 102, since the length of the light path 110 may be increased, while allowing for facilitated manufacturing process as mentioned above. The effective light source position is also shifted outwards, hence improving the touch performance at the edges of the touch surface 102.

FIG. 11a show another example of having the emitters 103 arranged to emit light in an outward direction with respect to the panel 101, here with the emitters 103 arranged below the touch surface 102, to provide for another alternative of folding and extending the light path 110.

FIG. 12 is another schematic illustration of an angular filter structure 112 having absorbing surfaces 128, 128′, arranged along the light path 110, which prevent light propagation at certain angular intervals. Thus, ambient light or system stray light is prevented from being reflected towards the detectors 104. Any plurality of surfaces 128, 128′, may be arranged along the light path 110. It is also conceivable that a specular reflecting surface may be arranged where the diffusive light scattering element 111 is show. As the light coupling element 106 can have a narrow width (since the angular filtering is provided by absorbing 128, 128′), the distance between the emitter 103 and the light coupling element 106 can be increased, allowing for scanline broadening. In another example, a diffusive light scattering element 111 may be arranged at the light coupling element 106 of FIG. 12. The absorbing surfaces 128, 128′, may be formed directly in the frame elements 120, 120′.

FIG. 13 is a schematic illustration where the emitters 103 (and detectors 104) have been mounted on a PCB being vertically arranged. The PCB may have an inner reflective side 131, which may have a reflective material, such as Au.

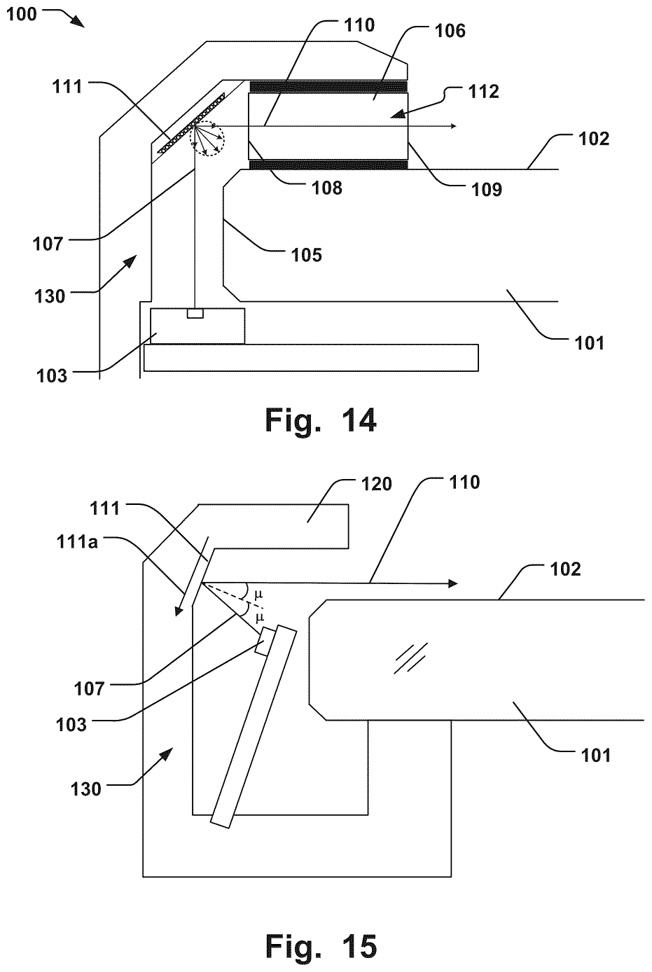

In the example of FIG. 14, the light coupling element 106 and angular filter structure 112 also extends in the direction of the plane of the touch surface 102 as an integral piece. The emitter 103 is arranged below the touch surface 102, and the light is instead scattered at a separate diffusive light scattering element 111 towards the angular filter structure 112. Also in this example, it is conceivable that the diffusive light scattering element 111 is arranged on, or in, the light coupling element 106/angular filter structure 112, and the emitted light may instead be specularly reflected at the surface where reference number 111 in FIG. 14 points.

The diffusive light scattering element 111, 111′, 111″, may be configured as an essentially ideal diffuse reflector, also known as a Lambertian or near-Lambertian diffuser, which generates equal luminance in all directions in a hemisphere surrounding the diffusive light scattering element. Many inherently diffusing materials form a near-Lambertian diffuser. In an alternative, the diffusive light scattering element 111 may be a so-called engineered diffuser with well-defined light scattering properties. This provides for a controlled light management and tailoring of the light scattering abilities. A film with groove-like or other undulating structures may be dimensioned to optimize light scattering at particular angles. The diffusive light scattering element 111 may comprise a holographic diffuser. In a variant, the engineered diffuser is tailored to promote diffuse reflection into certain directions in the surrounding hemisphere, in particular to angles that provides for the desired propagation of light above and across the touch surface 102.

The diffusive light scattering element may be configured to exhibit at least 50% diffuse reflection, and preferably at least 90% diffuse reflection.

The diffusive light scattering element 111, 111′, 111″, may be implemented as a coating, layer or film applied by e.g. by anodization, painting, spraying, lamination, gluing, etc. In one example, the scattering element 111, 111′, 111″, is implemented as matte white paint or ink. In order to achieve a high diffuse reflectivity, it may be preferable for the paint/ink to contain pigments with high refractive index. One such pigment is TiO₂, which has a refractive index n=2.8. The diffusive light scattering element 111, 111′, 111″, may comprise a material of varying refractive index. It may also be desirable, e.g. to reduce Fresnel losses, for the refractive index of the paint filler and/or the paint vehicle to match the refractive index of the material on which surface it is applied. The properties of the paint may be further improved by use of EVOQUE™ Pre-Composite Polymer Technology provided by the Dow Chemical Company. There are many other coating materials for use as a diffuser that are commercially available, e.g. the fluoropolymer Spectralon, polyurethane enamel, barium-sulphate-based paints or solutions, granular PTFE, microporous polyester, GORE® Diffuse Reflector Product, Makrofol® polycarbonate films provided by the company Bayer AG, etc.

Alternatively, the diffusive light scattering element 111, 111′, 111″, may be implemented as a flat or sheet-like device, e.g. the above-mentioned engineered diffuser, diffuser film, or white paper which is attached by e.g. an adhesive. According to other alternatives, the diffusive light scattering element 111, 111′, 111″, may be implemented as a semi-randomized (non-periodic) micro-structure on the external surfaces 113, 125, possibly in combination with an overlying coating of reflective material.

A micro-structure may be provided on the external surface 113, 125, and/or internal surface 114, 124, by etching, embossing, molding, abrasive blasting, scratching, brushing etc. The diffusive light scattering element 111, 111′, 111″, may comprise pockets of air along the internal surface 114, 124, that may be formed during a molding procedure of the light coupling element 106 and/or angular filter structure 112 (effectively forming part of the light coupling element 106 in some of the above described examples). It may also be possible to incorporate a film of diffusive properties into the internal surface 114, 124, when forming the light coupling element 106 and/or angular filter structure 112. In another alternative, the diffusive light scattering element 111, 111′, 111″, may be light transmissive (e.g. a light transmissive diffusing material or a light transmissive engineered diffuser) and covered with a coating of reflective material at an exterior surface. Another example of a diffusive light scattering element 111, 111′, 111″, is a reflective coating provided on a rough surface.

The diffusive light scattering element 111, 111′, 111″, may comprise lenticular lenses or diffraction grating structures. Lenticular lens structures may be incorporated into a film which is applied to the light coupling element 106 and/or angular filter structure 112. The diffusive light scattering element 111, 111′, 111″, may comprise various periodical structures, such as sinusoidal corrugations provided onto the internal surfaces 114, 124, and/or external surfaces of the light coupling element 106 and/or angular filter structure 112. The period length may be in the range of between 0.1 mm-1 mm. The periodical structure can be aligned to achieve scattering in the desired direction. E.g., in the examples shown in FIGS. 7a-b and FIG. 8, the diffusive light scattering element 111 may have a periodical sinusoidal corrugation aligned so that the ‘ridges’ of the corrugation extend longitudinally in a direction perpendicular to the plane of the touch surface 102. Hence, the light will be scattered in the aforementioned plane, as schematically illustrated in FIGS. 7a-b. In this case, having the angular filter structure 112 arranged in the light path before the diffusive light scattering element 111 provides for another alternative to achieve scan line broadening. In the example of FIG. 8, the light may be reflected towards the angular filter structure 112 of the light coupling element 106 by specular reflection at reflection surface 132.

The diffusive light scattering element 111, 111′, 111″, may be co-extruded with the light coupling element 106, and/or angular filter structure 112 in the manufacturing process.

Hence, as described, the diffusive light scattering element 111, 111′, 111″, may comprise; white-or colored paint, white-or colored paper, Spectralon, a light transmissive diffusing material covered by a reflective material, diffusive polymer or metal, an engineered diffuser, a reflective semi-random micro-structure, in-molded air pockets or film of diffusive material, different engineered films including e.g. lenticular lenses, or other micro lens structures or grating structures. The diffusive light scattering element 111, 111′, 111″, preferably has low NIR absorption.

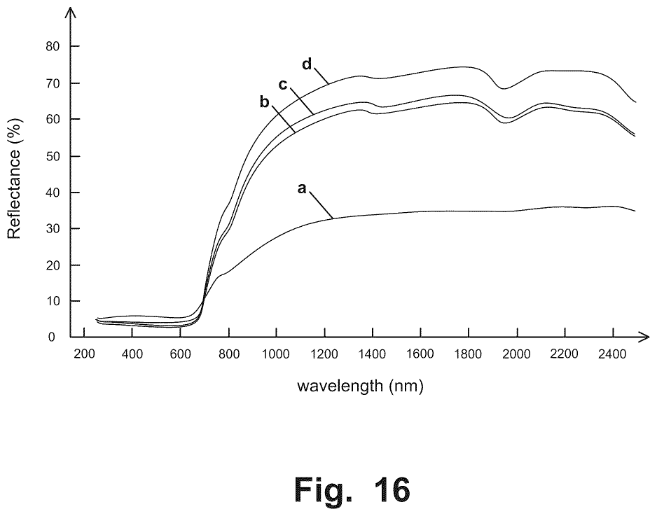

FIG. 15 is a schematic illustration where the emitters 103 (and detectors 104) have been arranged to direct light towards diffusive light scattering element 111, preferably at the smallest angle possible relative to the plane 102 of the touch surface. The diffusive light scattering element 111 may be formed from a grooved surface, wherein the grooves generally run generally vertically, i.e. in the plane of the schematic cross section and in the direction shown by arrow 111a, which is perpendicular to the normal of the surface of diffusive light scattering element 111. In other words, the grooves are orientated from a top edge to a bottom edge of the reflector surface such that the scattered light is primarily directed to the touch plane. Most preferably, the grooves occur in one direction. Generally speaking, the angle between the vertical (when the touch surface is horizontal) and the grooves should be minimized to optimize signal and scanline broadening. In this embodiment, the angle u between the normal of the grooved surface and light ray coming from the emitter component is same as angle u between normal of grooved surface and the plane of the light rays travelling to touch surface. i.e. The angle of the normal of the grooved surface bisects the angle of the light ray travelling to the grooved surface and the light ray travelling to the touch surface. Optionally, the arrangement of the grooves on the grooved surface is substantially randomized. The groove density is preferably greater than 10 per mm in a horizontal plane. Optionally, the groove depth is up to 10 microns. Preferably, the average groove width is less than 2 microns. The grooves forming the diffusive light scattering element 111 can be formed by scratching or brushing of the surface. In one embodiment, diffusive light scattering element 111 is formed from a surface of a frame element 120 directly. Frame element 120 may be an extruded profile component or, alternatively, frame element 120 is made from brushed sheet metal. Preferably, frame element 120 is formed from anodized metal, such as anodized aluminum, and the grooves of diffusive light scattering element 111 are formed from scratching or brushing the anodized layer of the aluminum. In one embodiment, the anodization is a reflective type. In one example, the anodized metal, e.g. anodized aluminium, is cosmetically black in the visible spectral range, but diffusively light scattering in the near infrared range, e.g. wavelengths above 800 nm. FIG. 16 shows an example of the total reflectance (%), i.e. diffusive and specular reflection, for black anodized aluminium as function of the wavelength (nm). The curves (denoted a-c) represent anodized aluminium material having undergone different treatments which affect the reflective characteristics. E.g. curve (c) represents raw anodized aluminium, while (b) is the machined anodized aluminium; (d) is polished anodized aluminium; and (a) is bead-blasted anodized aluminium, respectively. As seen in FIG. 16, the total reflectance increases with the wavelength in the range starting around 700 nm until about 1300 nm. It may be particularly advantageous to use wavelengths above 900 nm where many anodized materials start to reflect significantly (e.g. around 50%). FIG. 17 shows another schematic example of a touch sensing apparatus 100, described further below, where a frame element 120, 120′, may comprise black anodized aluminium where diffusive light scattering surfaces 111, 111′, 111″ are provided along the light path 110. The anodized surfaces may not only be used as a diffusive light scattering element but may also be utilized as a reflective element that allows better light management, e.g. recycling of light and reflecting light from lost directions towards the diffusive light scattering element 111.

Turning again to the light directing arrangement 130 shown in the example of FIG. 17, the light path 110 is directed through the panel 101, hitting an angled diffusive light scattering surface or element 111, which may be an anodized metal surface, e.g. anodized aluminium, as exemplified above. Further diffusive light scattering surfaces 111′, 111″, are provided on the opposite side of the panel 101 along a cavity 131 through which the light travels between the emitter 103 (or detector 104) and the backside of the panel 101. The anodized extruded aluminium part of the frame element 120, 120′, may be cosmetically black, but diffusively reflective in the infrared wavelengths. It is conceivable that other anodized metals and alloys may provide for an advantageous diffusive scattering of the light along the light path 110. This provides for a compact light directing arrangement 130 since separate diffusive light scattering elements may be dispensed with, and the number of components may be reduced.

A light absorbing surface 126 may be provided at the frame element 120 comprising the angled diffusive light scattering surface 111, arranged above the touch surface 102, as schematically illustrated in FIG. 17. The light absorbing surface 126 provides for reducing unwanted reflections from ambient light. The light absorbing surface 126 may be omitted in some examples, providing for reducing the height of the angled frame element 120 above the panel 101, i.e. to reduce the bezel height. A second light absorbing surface 126′ may be provided between the panel 101 and the frame element 120′, at the backside of the panel 101, opposite the touch surface 102, as schematically illustrated in FIG. 17 to further reduce unwanted light reflections from ambient light. The light directing arrangement 130 in the example of FIG. 17 may be particularly advantageous in some applications where additional compactness is desired, since a light coupling element 106 or angular filter structure 112 having a longitudinal portion 118 may be omitted. This provides also for reducing the cost of the touch sensing apparatus 100. The angle by which the light scatters across the panel 101 may be further increased, providing for an improved scanline coverage across the panel 101, as Fresnel reflection losses can be avoided with the light directing arrangement 130 exemplified in FIG. 17. The panel 101 may act as a sealing portion, similar to the transparent sealing portion 121 referred to above, to protect electronics from e.g. liquids and dust. The angles of incidence may preferably be kept low through the panel 101, compared to examples where a separate sealing portion 121 is placed after the diffusive light scattering element 111. The panel 101 may be provided with a print to block unwanted ambient light and to provide for a pleasing cosmetic appearance.

In a variation of any of the above embodiments wherein the diffusive light scattering element provides a reflector surface (e.g. FIGS. 1a-b, 2a-b, 4, 5, 8, 10, 11, 12, 13, 14, 15, 17), the diffusive light scattering element may be provided with no or insignificant specular component. This may be achieved by using either a matte diffuser film in air, an internal reflective bulk diffusor or a bulk transmissive diffusor. This allows effective scanline broadening by avoiding the narrow, super-imposed specular scanline usually resulting from a diffusor interface having a specular component, and providing only a broad, diffused scanline profile. By removing the super-imposed specular scanline from the touch signal, the system can more easily use the broad, diffused scanline profile. Preferably, the diffusive light scattering element has a specular component of less than 1%, and even more preferably, less than 0.1%. Alternatively, where the specular component is greater than 0.1%, the diffusive light scattering element is preferably configured with surface roughness to reduce glossiness. E.g. micro structured.

The touch sensing apparatus may further comprise a shielding layer (not shown). The shielding layer may define an opaque frame around the perimeter of the panel 102. The shielding layer may increase the efficiency in providing the diffusively reflected light in the desired direction, e.g. by recycling the portion of the light that is diffusively reflected by the diffusive light scattering element 111, 111′, 111″, in a direction away from the panel 101. Similarly, providing a shielding layer on the light coupling element 106, 112, or frame element 120, 120′, arranged at a detector 104 can further reduce the amount of stray light and ambient light that reaches the detector 104. The shielding layer may have the additional function of blocking entry of ambient light through the light coupling element 106, 112, or generally along the light path 110 between the diffusive light scattering element 111, 111′, 111″, and the detector/emitter 103, 104, as in FIG. 17.

The panel 101 may be made of glass, poly(methyl methacrylate) (PMMA) or polycarbonates (PC). The panel 101 may be designed to be overlaid on or integrated into a display device or monitor (not shown). It is conceivable that the panel 101 does not need to be light transmissive, i.e. in case the output of the touch does not need to be presented through panel 101, via the mentioned display device, but instead displayed on another external display or communicated to any other device, processor, memory etc.

As used herein, the emitters 103 may be any type of device capable of emitting radiation in a desired wavelength range, for example a diode laser, a VCSEL (vertical-cavity surface-emitting laser), an LED (light-emitting diode), an incandescent lamp, a halogen lamp, etc. The emitter 103 may also be formed by the end of an optical fiber. The emitters 103 may generate light in any wavelength range. The following examples presume that the light is generated in the infrared (IR), i.e. at wavelengths above about 750 nm. Analogously, the detectors 104 may be any device capable of converting light (in the same wavelength range) into an electrical signal, such as a photo-detector, a CCD device, a CMOS device, etc.

With respect to the discussion above, “diffuse reflection” refers to reflection of light from a surface such that an incident ray is reflected at many angles rather than at just one angle as in “specular reflection”. Thus, a diffusively reflecting element will, when illuminated, emit light by reflection over a large solid angle at each location on the element. The diffuse reflection is also known as “scattering”.

The disclosure has mainly been described above with reference to a few embodiments. However, as is readily appreciated by a person skilled in the art, other embodiments than the ones disclosed above are equally possible within the scope and spirit of the disclosure, which is defined and limited only by the appended patent claims.

For example, the specific arrangement of emitters and detectors as illustrated and discussed in the foregoing is merely given as an example. The inventive coupling structure is useful in any touch-sensing system that operates by transmitting light, generated by a number of emitters, across a panel and detecting, at a number of detectors, a change in the received light caused by an interaction with the transmitted light at the point of touch.

1.-19. (canceled)

20. A touch sensing apparatus comprising:
a panel that defines a touch surface, and
a plurality of emitters and detectors arranged along a perimeter of the panel,
wherein the emitters are arranged to emit a respective beam of emitted light, the emitted light has a light path to a light coupling element,
wherein the light coupling element is arranged adjacent the perimeter to receive the emitted light through a first surface and couple out light travelling in the light coupling element through a second surface thereof to direct the emitted light across the touch surface,
a diffusive light scattering element arranged in the light path between a respective emitter of the plurality of emitters and the light coupling element, and
wherein the diffusive light scattering element is separate from the light coupling element.

21. The touch sensing apparatus according to claim 20, wherein the diffusive light scattering element is placed with a spacing from the light coupling element.

22. The touch sensing apparatus according to claim 20, wherein the diffusive light scattering element is a transmissive diffusor.

23. The touch sensing apparatus according to claim 20, wherein the emitter is arranged below the touch surface.

24. The touch sensing apparatus according to claim 20, wherein the emitted light is reflected on a reflector surface of a frame element of the touch sensing apparatus.

25. The touch sensing apparatus according to claim 24, wherein the reflector surface is a metal surface of the frame element.

26. The touch sensing apparatus according to claim 24, wherein the reflector surface comprises a coating or a film.

27. The touch sensing apparatus according to claim 20, wherein the emitters are mounted to a printed circuit board (PCB), wherein the PCB is arranged in a vertical direction, perpendicular to a plane in which the panel extends.

28. The touch sensing apparatus according to claim 20, wherein the emitters are mounted to a printed circuit board (PCB), wherein the PCB is arranged in a horizontal direction, parallel to a plane in which the panel extends.

29. The touch sensing apparatus according to claim 20, wherein the emitter emits light in a vertical direction, perpendicular to a plane in which the panel extends.

30. The touch sensing apparatus according to claim 20, wherein the light path extends at least partly in a horizontal direction, parallel to a plane in which the panel extends, between the diffusive light scattering element and the light coupling element.

31. The touch sensing apparatus according to claim 20, wherein the emitter is arranged above the touch surface.

32. The touch sensing apparatus according to claim 20, wherein the emitter is arranged to emit light outwards towards the perimeter, wherein the emitted light is reflected back at the perimeter, by the diffusive light scattering element, towards the light coupling element.

33. The touch sensing apparatus according to claim 32, wherein the diffusive light scattering element is a reflective diffusor.
